(19) United States
(12) Patent Application Publication
(10) Pub. No.: US 2017/0252659 A1
(43) Pub. Date: Sep. 7, 2017

(54) Lighted Skeleton Figure Decoration

(71) Applicant: Kathleen Kreps, Loganville, GA (US)

(72) Inventor: Kathleen Kreps, Loganville, GA (US)

(21) Appl. No.: 15/255,343

(22) Filed: Sep. 2, 2016

Related U.S. Application Data
(60) Provisional application No. 62/303,451, filed on Mar. 4, 2016.

(51) Int. Cl. A63H 3/00; F21S 9/02; F21V 23/04; A63H 3/38

(52) U.S. Cl. CPC A63H 3/006; A63H 3/38; F21S 9/02; F21V 23/04; F21Y 2115/10

(57) ABSTRACT

A lighted decoration is provided having the form of a human skeleton figure. The figure is ornamental and has a head, a rib cage, a spine, arms, legs, and a hip bone. The skull has an open interior supporting a battery power supply therein, which supplies electrical power to the light sources of the figure. Light sources are disposed within the eye sockets of the skull, while the spine further comprises an open interior with one or more light sources supported therein. The light sources of the spine are disposed within a tubular interior thereof, or alternatively are situated within individual spinal processes extending outwardly from the tubular body of the spine. Furthermore, a heart-shaped housing within the rib cage additionally may be provided with a light source therein. One or more switches and an optional controller unit govern the operation of the light sources throughout the figure.

### CROSS REFERENCE TO RELATED APPLICATION

This application claims the benefit of U.S. Provisional Application No. 62/303,451 filed on Mar. 4, 2016. The above identified patent application is herein incorporated by reference in its entirety to provide continuity of disclosure.

### BACKGROUND OF THE INVENTION

Field of the Invention

The present invention relates to ornaments and lighted displays. More specifically, the present invention relates to a lighted ornament in the shape of a human skeleton that includes light sources in different parts of the body to provide a unique declaration for Halloween or other occasion.

Many people enjoy the holiday of Halloween because they can dress in different costumes and garnish their homes with scary and spooky themed decorations. For this, the present invention provides a new and unique decoration in which an illuminated figure is provided forming the shape of a human skeleton. The figure forms a declaration having a skull, rib cage, arms, legs, and a spine, whereby light sources are provided therealong to illuminate different parts of the skeleton body. The figure is adapted to be suspended and illuminated so that it can be seen in the dark.

In particular, the skeleton figure and declaration of the present invention includes light sources disposed within the eye sockets of the skeleton skull, along the spine of the figure, and optionally within the rib cage. The light sources may be traditional filament bulbs or light emitting diodes, while their operation is controlled either manually or via a controller unit that can alternate a pattern of light from the different sources over a period of time. The present invention is designed to provide a new and unique declaration forming a skeleton figure with several embedded light sources therein.

### SUMMARY OF THE INVENTION

The following summary is intended solely for the benefit of the reader and is not intended to be limiting in any way. The present invention provides a new lighted skeleton figure decoration that can be utilized for adorning and decorating a space in a festive and spooky style.

It is therefore an object of the present invention to provide a new and improved lighted skeleton decoration that has all of the advantages of the prior art and none of the disadvantages.

It is another object of the present invention to provide a lighted skeleton decoration having the form of a human skeleton figure or ornament with a head, a rib cage, a spine, arms, legs, and a hip bone.

Another object of the present invention is to provide a lighted skeleton decoration in which the rib cage has an open interior and connects to the spine along a backside of the rib cage. The spine extends substantially vertically along the human skeleton ornament, whereby the hip bone is connected along a base of the spine and the legs are connected to the hip bone. The rib cage has a pair of sides and the arms are connected to the rib cage along the sides. Finally, the skull is supported by the spine along an upper end thereof.

Another object of the present invention is to provide a lighted skeleton decoration whereby the skull has an open interior supporting a battery power supply therein. The battery power supply is adapted to provide electrical energy to a plurality of light sources disposed within the skeleton ornament.

Another object of the present invention is to provide a lighted skeleton decoration wherein the skull further comprises two eye sockets, each socket having a light source therein. The two eye sockets of the skull may additionally comprise a lens disposed thereover, whereby the lens may have a design, indicia, or particular color.

Another object of the present invention is to provide a lighted skeleton decoration in which the spine further comprises an open interior with one or more light sources therein. The spine comprises an elongated, tubular interior extending from the upper end thereof and to its base. The light sources are disposed either within the tubular interior, or alternatively within individual spinal processes extending from the tubular body of the spine along its length. This latter embodiment, the spine further comprises a plurality of protrusions extending therefrom, forming the shape of individual spinal processes. The spinal processes are arranged in three substantially vertical rows along the length of the spine, from the upper end and to the base. The light sources are disposed within the tubular interior of the spine or alternatively within the individual processes thereof.

Another object of the present invention is to provide a lighted skeleton decoration wherein the light sources of the skull and the one or more light sources of the spine are electrically connected to the battery power supply in the skull such that the light sources are energized by the battery power supply and illuminate the eye socks and spine of the human skeleton ornament.

Another object of the present invention is to provide a lighted skeleton decoration whereby a housing is disposed within the open interior of the rib cage. The housing further comprises a light source therein, whereby the light source is connected to the battery power supply and illuminates the housing within the open interior of the rib cage. The housing is preferably heart-shaped, either anatomically resembling a human heart or resembling a two-lobed, decorative heart symbol.

Another object of the present invention is to provide a lighted skeleton decoration wherein the skull further comprises an elongated tether extending from an upper surface thereof for hanging the human skeleton ornament.

Another object of the present invention is to provide a lighted skeleton decoration whereby one or more electrical switches are disposed between the battery power source and the light sources of the skull, the one or more light sources of the spine, and the heart-shaped housing of the rib cage.

Another object of the present invention is to provide a lighted skeleton decoration that further comprises a controller unit to govern the flow of current from the battery power source and to the light sources of the ornament in order to create a preprogrammed pattern of light source energization over a period of time.

Another object of the present invention is to provide a lighted skeleton decoration wherein the light sources of the skeleton ornament are light emitting diodes.

Another object of the present invention is to provide a lighted skeleton decoration whereby the skull further comprises a rear surface, and whereby the rear surface further comprises an access door for access to the battery power source.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal perspective view of the lighted skeleton decoration of the present invention.

FIG. 2 shows a rear view of the rib cage of the lighted skeleton decoration of the present invention.

FIG. 3 shows a cross section view of the skull of the lighted skeleton decoration of the present invention.

FIG. 4 shows a rear view of an embodiment of the spine of the lighted skeleton decoration of the present invention.

FIG. 5 shows a side view of the spine and heart-shaped housing of the lighted skeleton decoration of the present invention.

### DETAILED DESCRIPTION OF THE INVENTION

Reference is made herein to the attached drawings. Like reference numerals are used throughout the drawings to depict like or similar elements of the lighted skeleton decoration of the present invention. For the purposes of presenting a brief and clear description of the present invention, the preferred embodiment will be discussed as used for festive decoration and for providing a lighted ornament that can be illuminated manually or via a controller unit that varies the light sources therein. The figures are intended for representative purposes only and should not be considered to be limiting in any respect.

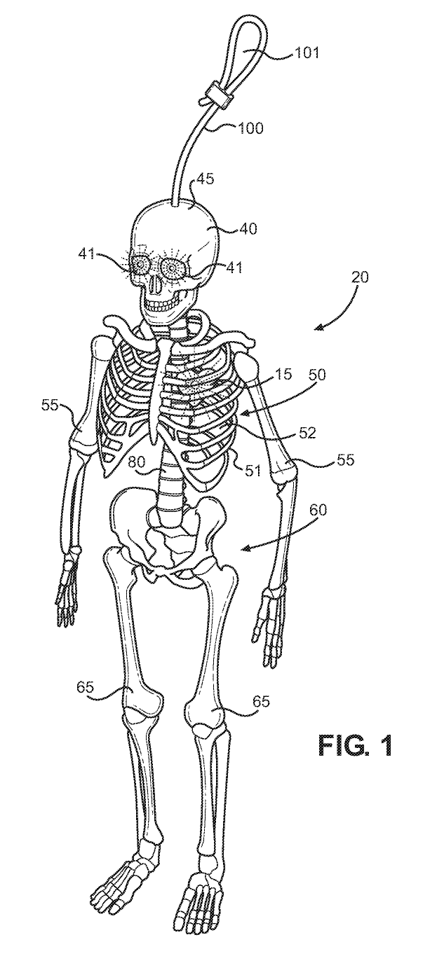

Referring now to FIG. 1, there is shown a frontal perspective view of the lighted decoration of the present invention. The present invention comprises a lighted ornament in the form of a human skeleton FIG. 20. The FIG. 20 comprises a head 40, a rib cage 50, a spine 80, arms 55, legs 65, and a hip bone 60 in the formation of a human skeletal structure. The FIG. 20 is designed to represent a human skeleton for decoration purposes, whereby the FIG. 20 serves as spooky decoration during Halloween and other events. Several light sources are disposed throughout the FIG. 20, including within the skull 40, rib cage 50, and along the spine 80. The light sources are controlled manually via electrical switches, or alternatively by a controller unit that can coordinate the light sources and energize them in a pattern or for a given time. Preferably, the FIG. 20 is suspended from a tether 100 and from a support, and the light sources are active at night to provide a decorative ornament.

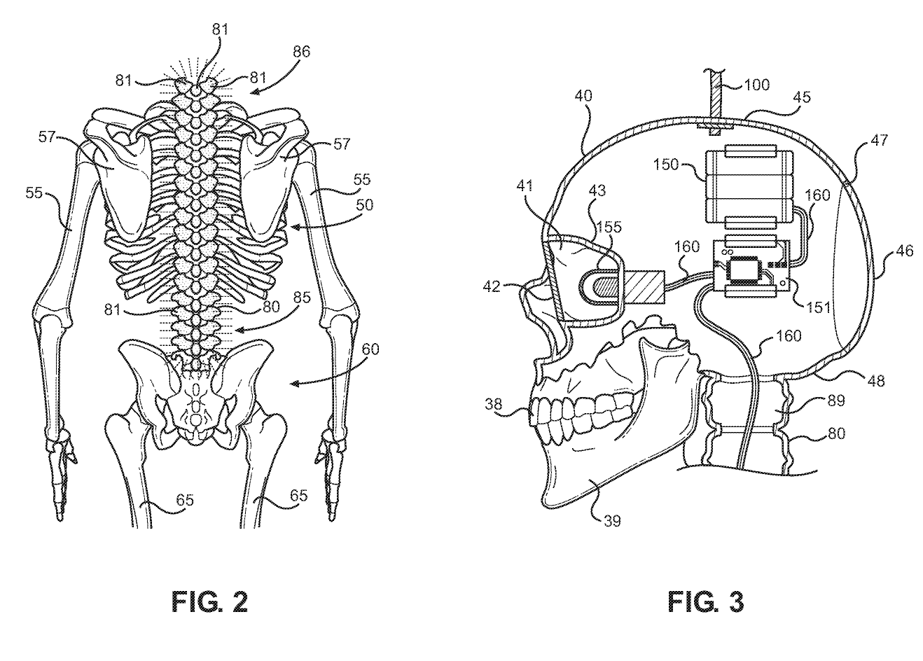

Referring to FIGS. 1 through 5, there are shown various aspects of the lighted decoration and the location of the various light sources. In FIG. 1, the basic structure of the skeleton figure is shown. The FIG. 20 includes a rib cage 50 with an open interior 52 and connected to the spine 80 along a backside of the rib cage 50. The rib cage 50 preferably has an open structure with individual ribs 51, whereby the open interior 52 is visible from the exterior of the rib cage 50. The spine 80 extends substantially vertically along the figure and connects to the hip bone 60 along the base of the spine 80. The legs 65 are thereafter connected to the hip bone 60 and are suspended therefrom. Along the upper end of the rib cage 50, the arms 55 connect to a pair of sides thereof and are also suspended therefrom. Finally, the skull 40 is supported along the upper end of the spine 80, whereby the skull 40 is supported by the tether 100 in a suspended state.

Referring to FIGS. 1 and 3, the skull 40 is shown in greater detail. The skull 40 forms the general shape of a human skull with a crown 45, a rear (parietal) surface 46, eye sockets 43, a jaw bone 39, and teeth 38. The spine 80 secures to the base 48 of the skull 40 and supports the skull 40 therefrom. The tether 100 secures to the crown 45 of the skull 40 and extends upwardly therefrom. The skull 40 finally comprises an open interior within which a battery power supply 150, wiring 160, switches, an optional controller 155, and light sources 155 are disposed. Along the rear surface 46 of the skull 40 is preferably a removable or hinged 47 access door, through which the open interior of the skull and thus the battery pack 150 and switches may be accessed.

In particular, the skull 40 comprises a pair of eye sockets 41 along the frontal portion thereof that resemble the eyes of the skeleton figure. The eye sockets 41 are depressions in the skull forming cavities therealong. The sockets include an inner wall 43 and a light source 155 disposed therein, whereby the light source 155 is wired 160 to the battery power source 150 and optionally the controller and/or switch 151. The light sources within the sockets 41 energize when current from the batteries 150 flows thereto and is controlled by the switch/controller 151. The light sources 155 may be colored or may be clear light. In addition, a lens 42 may be disposed over the eye sockets 41 in order to shroud the light sources 155 and additionally provide a colored lens thereover. A colored lens 42 may be used to project a particularly colored light from the eye sockets 41. These lenses 41 may be affixed thereto or may be removable for access to the light source 155 and optionally to change the color of the lens 42.

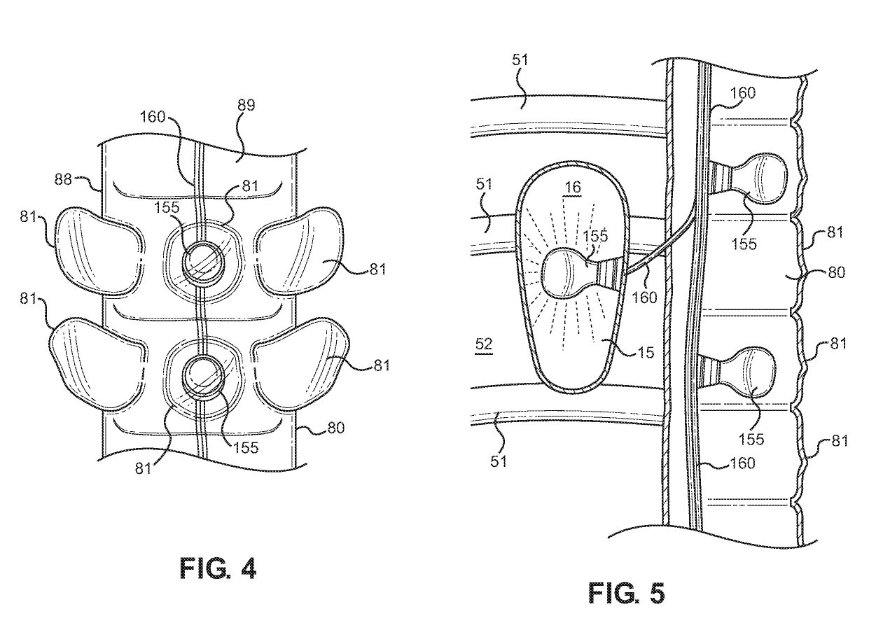

Referring to FIGS. 1 through 5, the spine 80 of the FIG. 20 is shown in greater detail. The spine 80 comprises an elongated, tubular member 88 with an open interior 89 extending from the upper end 86 and to the base 85 thereof. Within the interior of the spine 80 are one or more light sources 155 therein. The light sources 155 are disposed within the open interior 89 or are disposed within individual spinal processes 81 extending outward from the tubular body 88 of the spine 80. As shown in FIG. 4 and FIG. 5, one embodiment contemplates a row of vertically aligned light sources 155 within the tubular interior 89 of the spine. The light sources 155 are connected by wiring 160 that extends upwards in the skull and connects to the battery power source and controller/switch.

In another embodiment, the light sources 155 of the spine 80 are disposed within individual spinal processes 81. The spinal processes 81 are protrusions extending from the tubular body 88 of the spine 80 that form individual interior volumes. Within each of the processes 81 may be an individual light source 155 therein. In this latter embodiment, the processes 81 align substantially vertically and form rows of three along the length of the spine 80. With a light source in each, the individual spinal processes 81 are individually illuminated by each light source.

Referring now to FIG. 5, there is shown an embodiment of the rib cage 50 in which a heart-shaped housing 15 is disposed therein. In this embodiment, a housing 15 is supported and disposed within the open interior 52 of the rib cage 50. The housing 50 comprises a closed volume 16 with transparent or translucent sidewalls, whereby the interior supports a light source 155 therein. The light source 155 is connected to the battery power supply in the skull and illuminates the housing 15 within the open interior 52 of the rib cage 50. In turn, the illuminated housing 15 is visible through the openings in the rib cage 15 between the ribs 51. The housing 15 is preferably supported by the spine 80 or by the rib cage 50 itself, and takes the form of anatomical heart-shape or a heart symbol. That is, the sidewalls of the housing form a human heart shape or a heart symbol that is illuminated when the light source 155 therein illuminates.

All of the light sources 155 in the ornament, including those of the skull 40, the spine 80, and the heart-shaped housing 15 are electrically connected to the battery power supply 150 in the skull 40. The light sources 155 are energized by the battery power supply 150 and illuminate the eye socks 41, the spine 80, and optionally the heart 15 of the ornament when current flows thereto. The battery power source 150 comprises one or more batteries that are electrically connected via wiring 160 to the individual light sources 155 distributed throughout the ornament. Additionally, a controller or switch 150 may be provided within the skull interior that allows the user to manually control the operation of the light sources or run a program on the controller that illuminates the light sources intermittently or on a scheduled program (i.e. during night time hours, etc.). It is not desired to limit the present invention to a particular switch or controller, but rather to provide an optional means of energizing the light sources either manually or via a controller that can be programmed to energize and turn off the lights based on user preference. In the simplest embodiment, a manual switch 151 is provided that the user accesses through the access door of the skull to turn on the light sources. In addition, the light sources 155 of the ornament may comprise one of filament bulbs or light emitting diodes (LEDs). For LEDs, an LED circuit may additionally be required to control voltage to the individual diodes, in addition to a switch and/or controller in the skull.

Overall, the present invention provides a skeleton figure decoration taking the form of a scaled or full-sized human skeleton shape, which is adapted to be suspended from tether 100. The tether 100 may form a loop 101, such that the tether may be supported by a hook or other article of hardware or support. The skeleton figure includes light sources disposed throughout so as to illuminate the figure's eyes and other portions in a spooky or ornamental fashion. The device is ideal for decorative purposes, particularly for events and holidays such as Halloween.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A lighted decoration, comprising:
a human skeleton ornament having a head, a rib cage, a spine, arms, legs, and a hip bone;
the rib cage having an open interior and connecting to the spine along a backside of the rib cage;
the spine extending substantially vertically along the human skeleton ornament;
whereby the hip bone is connected along a base of the spine, and the legs are connected to the hip bone;
the rib cage having a pair of sides, whereby the arms are connecting to the rib cage along the sides;
the skull being supported by the spine along an upper end thereof;
the skull having an open interior supporting a battery power supply therein;
wherein the skull further comprises two eye sockets, each having a light source therein;
the spine further comprising an open interior with one or more light sources therein; and
wherein the light sources of the skull and the one or more light sources of the spine are electrically connected to the battery power supply in the skull such that the light sources are energized by the battery power supply and illuminate the eye socks and spine of the human skeleton ornament.

2) The lighted decoration of claim 1, further comprising:
a housing disposed within the open interior of the rib cage;
the housing further comprising a light source therein;
wherein the light source is connected to the battery power supply and illuminates the housing within the open interior of the rib cage.

3) The lighted decoration of claim 2, wherein the housing is heart-shaped.

4) The lighted decoration of claim 1, wherein:
the spine further comprises a plurality of protrusions extending therefrom, forming the shape of individual spinal processes;
wherein the processes form three substantially vertical rows along the spine from the upper end and to the base;
wherein each of the processes has a light source disposed therein.

5) The lighted decoration of claim 1, wherein:
the spine further comprises an elongated, tubular interior extending from the upper end and to the base;
wherein the one or more light sources of the spine are disposed substantially vertically within the elongated, tubular interior thereof.

6) The lighted decoration of claim 1, wherein:
the skull further comprises an elongated tether extending from an upper surface thereof for hanging the human skeleton ornament.

7) The lighted decoration of claim 1, further comprising one or more electrical switches between the battery power source and the light sources of the skull and the one or more light sources of the spine.

8) The lighted decoration of claim 2, further comprising an electrical switch between the battery power source and the light source the housing.

9) The lighted decoration of claim 1, further comprising a controller unit to control the flow of current from the battery power source and to the light sources to create a preprogrammed pattern of light source energization over a period of time.

10) The lighted decoration of claim 1, wherein the light sources of the skull and the one or more light sources of the spine are one or more light emitting diodes.

11) The lighted decoration of claim 2, wherein the light source of the housing is one or more light emitting diodes.

12) The lighted decoration of claim 1, wherein:
the skull further comprises a rear surface;
the rear surface further comprises an access door for access to the battery power source.

13) The lighted decoration of claim 1, wherein the two eye sockets of the skull each further comprise a lens thereover.
